(19) United States
(12) Patent Application Publication
(10) Pub. No.: US 2024/0275599 A1
(43) Pub. Date: Aug. 15, 2024

(54) SECURE ELEMENT, METHOD FOR REGISTERING TOKENS, AND TOKEN REFERENCE REGISTER

(71) Applicant: GIESECKE+DEVRIENT ADVANCE52 GMBH, München (DE)

(72) Inventors: Daniel ALBERT, Munchen (DE); Deepen MANTRI, Munchen (DE)

(21) Appl. No.: 18/681,041

(22) PCT Filed: Jul. 27, 2022
(86) PCT No.: PCT/EP2022/025356

§ 371 Date: Feb. 3, 2024

(30) Foreign Application Priority Data
Aug. 4, 2021 (DE) 10 2021 004 019.8

(51) Int. Cl. H04L 9/32; G06Q 20/38; G06Q 20/40

(52) U.S. Cl. CPC H04L 9/3213; G06Q 20/382; G06Q 20/401

(57) ABSTRACT

A secure element relates to a transaction unit and to a method for registering tokens of an electronic transaction system, which includes the secure element acting as a transaction unit and a token reference register. Each token of the transaction system has at least one token value and one private part of a token-individual key pair acting as token elements.

### FIELD OF THE DISCLOSURE

The invention relates to secure elements as transaction units, a method for registering tokens of an electronic transaction system which comprises in particular the secure elements as transaction units and a token reference register. In addition, the invention relates to the token reference register, in which the token references that are uniquely assigned to a token are stored.

### BACKGROUND

With the aid of secure elements, such as chip cards, SIM modules, etc., as transaction units, it is known that a secure direct transmission between the transaction units can be achieved, wherein deliberate multiple outputs of tokens, also referred to as double-spending, are already ruled out.

For example, DE 10 2009 038 645 A1 and DE 10 2009 034 436 A1 describe systems or portable data carriers as secure elements for transmitting monetary values in the form of electronic data sets in which payment with duplicates of the data record is prevented and a high degree of manipulation security is provided. Complex structures and complex encryption and signing processes for the transactions are required here. These have not been found to be very practicable.

Different approaches are known to ensure the security of an electronic transaction system, in particular in the field of central bank digital currency (CBDC), a distinction is regularly made between token-based and access-based systems.

For access-based systems, such as WO 2016/200885 A1, a method for encrypting an amount transferred by means of a blockchain ledger has already been described, wherein the verifiability of the transaction in terms of the amount is maintained. These transaction systems based on blockchain topologies provide a high level of integrity protection. When data sets in a blockchain topology change hands, a lot of information is published. For example, a unique address of a subscriber unit is registered in the blockchain in a verifiable manner. Thus, blockchain transactions are not anonymous. In addition, these transactions are very computationally intensive and therefore energy-intensive.

It is likewise already known to expand a token-based transaction system by a token register. The secure element sends a registration request for its token to the register. The register verifies the registration request and only stores a token reference for the token, so preferably does not know the token itself. The invention makes use of a method for registering tokens that are transmitted as part of a direct communication between subscriber units.

WO 2020/212337 A1 describes a transaction system in which even modifications at the token—for example by splitting the token—are possible in a secured fashion off-line, that is to say, directly between the secure elements of the transaction system and without a further control entity. After receipt in a secure element or a subscriber unit, the tokens can be transmitted immediately without having to register a modification in a token register of the transaction system. However, the secure elements are known to be resource-limited, in particular limited with regard to memory space, processing speed and/or transmission speed.

The subscriber units, in particular secure elements, of a transaction system, should be able to pay flexibly with tokens in the transaction system. It is a challenge, especially for secure elements, if a sequence of transactions with a token or a part thereof or in combination with other tokens has taken place directly between subscriber units and, only after that, a registration of a token with all the modifications to the token should take place.

### SUMMARY

Here, the invention makes uses of a method for registering tokens that can be transmitted directly between subscriber units. In particular, the invention relates to the processing of a group, hereinafter also referred to as a batch or sequence, of registration requests.

The invention is based on the object of creating a method for registering tokens of a transaction system in which a sequence of transactions between different subscriber units of the transaction system with a token or a part thereof or in combination with other tokens is designed to be secure but nevertheless simple. This sequence of transactions should remain anonymous for third parties, i.e. a received token should be secret to all subscriber units not involved in the transaction. After receipt in a subscriber unit, tokens should be able to be further used immediately in order to enable a transaction even without merging to a remote unit, for example to a central register or a decentralized ledger. Each subscriber unit of the transaction system should be able to check a token obtained; in particular multiple output attempts and attempts to transmit unavailable token values can be detected by a subscriber unit or generally in the transaction system. The number of transactions in sequence should be unlimited. The registration of a sequence of transactions should be simple and secure.

The object is achieved in particular by a method for registering tokens of an electronic transaction system, wherein each token of the transaction system comprises at least a token value and a private part of a token-individual key pair as token elements.

The method comprises the method steps of receiving, in a token reference register of the transaction system, a sequence of registration requests, each registration request of the sequence having a first token reference and at least one second token reference, and at least one token reference of a first registration request of the sequence and a token reference of a second registration request of the sequence being identical; verifying, using a verification unit of the token reference register, whether at least one of the at least one token reference contained in the received sequence of registration requests can be uniquely assigned to a first token of the transaction system, the token reference being checked to see whether it is or was stored in the token reference register, storing at least one token reference other than the checked token reference from the sequence of registration requests in the memory unit of the token reference register for registering the token uniquely assigned to this token reference in the transaction system, if it is established in the verification step that the checked token reference of the received sequence of register requests can be uniquely assigned to the first token of the transaction system and if the other token reference is not yet stored in the token reference register.

After the receiving and verification and storage step, a next registration request from the sequence of registration requests can be processed.

Security of transactions and the associated transaction data means protecting the confidentiality of the exchanged data; as well as protecting the integrity of the exchanged data; as well as protecting the availability of the exchanged data.

In this way, a sequence of transactions in a direct transaction layer of the transaction system can be verified directly between subscriber units with a token and, if necessary, modifications. The token reference register then receives a registration request for each of the transactions in the sequence and checks the extent to which token references can be assigned to tokens of the transaction system in order to verify the tokens and thus also the transactions.

The sequence of registration requests relates to requests for registering tokens that are not yet registered in the transaction system. These tokens have been directly exchanged between subscriber units and may have been modified several times. In order to carry out the registration of (all) these tokens relating to these registration requests, these registration requests no longer have to be made individually according to the invention, but can be processed as a sequence of registration requests.

A sequence of register requests represents a plurality of different registration requests relating to a token in the transaction system. The plurality can also be referred to as a block or as a bundle. The token to be stored or in question was modified multiple times (at least twice) and none of these modifications was captured in the token reference register in order to register the token with its modifications.

Receiving preferably takes place at an interface of the token reference register, preferably an interface of the verification unit of the token reference register.

Each registration request in the sequence therefore has at least two token references. For a split or merge modification of a token, three token references are provided per registration request. For a switch modification of a token, two token references are provided per registration request.

The token references of a sequence of registration requests are not independent of one another, at least two or more token references of the sequence are linked to one another or map to one another. Thus, at least one token reference of a first registration request of the sequence and one token reference of a second registration request of the sequence are identical, i.e. the token reference of the first registration request of the sequence is the same as the token reference of the second registration request of the sequence.

A transaction system is a system in which at least two, preferably a plurality of subscriber units can exchange (transmit) tokens directly amongst one another. The transaction system is, for example, a payment transaction system for exchanging monetary values in the form of payment tokens.

Preferably, each token reference from the sequence of registration requests was (past) or is (present) uniquely assigned to a token in the transaction system. This assignment will be discussed in detail later. These tokens were transmitted directly between subscriber units of the transaction system in a direct transaction layer of the transaction system or were modified by one or more subscriber units without these transmitted tokens and/or modified tokens being registered in the transaction system. In particular, the (input) token references of transmitted tokens and/or modified tokens in the sequence of registration requests were not stored in the token reference register.

A modification to a token is, in particular, the splitting (SPLIT) of tokens (or their token value) or the merging (MERGE) of at least two tokens (or their token values) or the switching (SWITCH) of the token from one subscriber unit to another subscriber unit. These modifications are described in more detail below.

Preferably, the entire sequence of registration requests is received in the token reference register before the verification step is executed, whereby each (input) token reference from each registration request must be verified. Each registration request from the sequence is received and verified in the token reference register and then stored or not stored in the memory unit based on the verification result.

Storing can take place before another registration request from the sequence is verified. Storing can take place immediately after verification, for example before another registration request is received and/or verified.

Preferably, the entire sequence of registration requests is sent from a subscriber unit of the transaction system to a registration request unit of the transaction system before the verification step is executed. The registration request unit is an instance of the transaction system that manages the registration of the entire sequence for a subscriber unit. The subscriber unit thus delegates the registration of the entire sequence to the registration request unit. This reduces the number of (individual) registration requests from the subscriber unit to the token reference register and also the administrative effort per subscriber unit.

The token reference register sequentially receives and verifies each registration request from the sequence of registration requests from the registration request unit before the next registration request from the sequence of registration requests is received and verified by the registration request unit. This means that all registration requests are processed one after the other and stored in the memory unit according to the verification result after verification.

In a less preferred embodiment, the token reference register sequentially receives and verifies each registration request from the sequence of registration requests from the subscriber unit before the next registration request from the sequence of registration requests is received and verified by the subscriber unit. This means that all registration requests are processed one after the other and stored in the memory unit according to the verification result after verification.

The token reference register can verify (specifically its verification unit) and store (specifically its memory unit) individual registration requests (i.e. individual registration requests relating to a token and/or its modification) or registration request batches (i.e. a plurality of individual registration requests relating to different tokens and/or their one modification) or also sequences of registration requests (i.e. a plurality of individual registration requests relating to the same token and/or its modification).

Individual registration requests or parts of a registration request batch can be distributed to different verification units of a token reference register and these can thus be processed in parallel by different verification units of the token reference register. This means that a large number of registration requests can be distributed internally in the token reference register to different verification units (“load balancing”).

Any sequence of registration requests can and should be processed sequentially. In one embodiment, the subscriber unit and/or the registration request unit sends each registration request from the sequence of registration requests sequentially as an individual registration request to the token reference register without the token reference register, specifically the verification unit, being aware that this individual registration request is part of a sequence of registration requests. The sequence of registration requests is generally provided by a subscriber unit.

Each registration request in the sequence comprises at least one token reference as an output token reference and at least one input token reference.

In a SWITCH modification, the registration request comprises precisely one token reference as an output token reference and precisely one input token reference. In a SPLIT modification, the registration request comprises precisely one (or more) input token reference(s) and at least two token references as output token references. In a MERGE modification, the registration request comprises at least two token references as input token references and precisely one (or more) output token reference(s).

The registration requests in the sequence are linked to one another via their token references; in particular, an output token reference of a registration request in the sequence forms an input token reference of (one of) the next registration request(s) in the sequence.

In a preferred embodiment, the method comprises the further steps of generating, from the verification unit of the token reference register, a registration response, the registration response indicating a result of the verification step, and sending the registration response to a subscriber unit or registration request unit of the transaction system sending the registration request from the sequence of registration requests, preferably the subscriber unit having the token of the at least one token reference of the sequence of registration requests.

Preferably, the registration response to the subscriber unit relates to all registration requests from the sequence. If the sequence is sent to the token reference register as part of individual registration requests, the registration response only relates to the respective individual registration request.

A registration response comprises information, preferably registration status information (status, status code) relating to the result of the verification step.

If, for example, it is determined in the verification step that the at least one token reference of the received register request can be uniquely assigned to a token of the transaction system and, as a result, the token is registered by storing the token reference in the transaction system, this information comprises a positive registration status.

A positive registration status of a registration response can apply to the entire sequence of registration requests, for example if at least one token reference of the chronologically last registration request from the sequence of registration requests can be uniquely assigned to a token of the transaction system. If a token is successfully assigned to the chronologically last token reference within a sequence of registration requests in this way, it is assumed that all other token references in the sequence of registration requests can also be uniquely assigned to a token or have been assigned to a token in the past. Only the registration response of one (of the last) registration requests is then received in the subscriber unit.

If, for example, it is established in the verification step that the at least one token reference of the received register request cannot be uniquely assigned to a token of the transaction system and, as a result, the token is not registered, this information comprises a negative registration status.

In addition to the registration status information, the registration response preferably also comprises the registration request to which the registration response relates. This allows the subscriber unit to check whether the registration response is valid or whether an attempt has been made to tamper with it.

In the case of a positive registration status, the registration request contained in the registration response may relate to the last (chronologically last) registration request received from the sequence of registration requests.

In the case of a negative registration status, the registration request contained in the registration response may relate to the first (chronologically first) registration request from the sequence of registration requests which temporally follows a registration request in the sequence whose token reference could be uniquely assigned to a token of the transaction system. The contained registration request is therefore chronologically the first registration request for which no unique assignment of a token could be verified in the verification step.

The registration response is preferably signed with a private part of a key pair of the token reference register, preferably of the verification unit (optionally one of a plurality of verification units). This signature is checked by the subscriber unit with the public part of the key pair of the token reference register when the registration response is received. This increases security, as registration responses created by unauthorized third parties—for example as part of man-in-the-middle attacks—are detected by a subscriber unit due to a missing or invalid signature. Such registration responses can then be ignored by the subscriber unit.

In one embodiment, a registration response with a token reference signature is generated only for the (chronologically) last verified registration request (token reference can be assigned to a token) from the sequence of registration requests, and this signed registration response is sent to the subscriber unit or the registration request unit.

In one embodiment, a registration response with a token reference signature is generated from the sequence of registration requests for all successfully verified registration requests (each token reference can then be uniquely assigned to a token), and this signed registration response is sent to the subscriber unit or the registration request unit.

In a preferred embodiment, the sequence of registration requests is stored in an archiving unit. This allows all registration requests to be archived in the token reference register. This makes it possible to check token references even at a much later point in time.

The archiving unit is preferably a unit of the token reference register.

In one embodiment, each registration request also comprises information about a command type. This command type informs the token reference register what type of modification has been made to the token and thus indicates to the token reference register what information is subsequently contained in the registration request.

In one embodiment, the registration requests are stored in full in the archiving unit. This means that the registration requests and the token references contained therein as well as a command type are stored. In the event of an error, this allows all token references to be checked so that tokens can still be registered at a later point in time.

In one embodiment, a registration request is deleted from the archiving unit when a predefined period of time has elapsed since the registration request was archived in the archiving unit. This predefined period of time is, for example, 1 year or a plurality of months, for example 12 months, 9 months, or 6 months. After this period of time, the probability that this registration request will have to be checked again decreases. The archiving unit is thus used for checking old registration requests, with an automatic deletion process ensuring, after the period of time has expired, that the amount of data in the archiving unit is not unnecessarily large.

In a preferred embodiment, each registration request is stored in an archiving unit of the token reference register, preferably in a first part of the archiving unit, if it is established in the verification step that the at least one token reference of one of the registration requests of the sequence of registration requests cannot be uniquely assigned to a token of the transaction system. Registration requests are therefore stored in the archiving unit (for example in the first part thereof) for which the token reference could not be uniquely assigned to a token in the verification step. This is the case, for example, if the token of the token reference is the result of a split modification and only one token reference of the at least two token references of the split tokens is known to the token reference register. This is also the case, for example, if no token exists for the token reference, i.e. token values have been generated illegally.

In a preferred embodiment, each registration request is stored in an archiving unit of the token reference register, preferably in a first part of the archiving unit, if it is established in the verification step that the at least one token reference of one of the registration requests of the sequence of registration requests is already stored in the token reference register. Accordingly, registration requests that are already stored in the token reference register are stored in the archiving unit (for example, in a first part thereof). This is the case, for example, if an unauthorized attempt is made to issue a token more than once.

Preferably, a sequence of registration requests with token references is stored in a second part of the archiving unit if all token references of the sequence of registration requests can each be uniquely assigned to a token of the transaction system.

With the archiving unit, the token reference register is advantageously able to resume aborted processing or only partial processing of a sequence of registration requests.

This abort or only partial processing (execution) can occur due to network or transmission errors. During registration of the sequence of registration requests, i.e. after registering one of the registration requests in the sequence by storing the token reference in the memory unit but before registering the last registration request in the sequence, problems occur with the data transmission of the other registration requests from the sequence. The memory unit has already been partially updated, but the sequence has not been fully processed. In order to be able to map and resolve this event of an error, the archiving unit is provided in which the part of the sequence that has already been processed is archived.

This abort or only partial processing (execution) can occur due to a malfunction of a subscriber unit. For example, a malicious subscriber entity has deliberately changed either the order of the registration requests or the syntax of the registration requests, as a result of which the token reference register cannot verify a registration request (fraud attempt). For example, invalid registration requests were received in the sequence of registration requests due to incorrect behavior of the subscriber unit or due to data transmission errors or for other reasons. The memory unit has already been partially updated, but the sequence has not been fully processed. In order to be able to map and resolve this event of an error, the archiving unit is provided in which the part of the sequence that has already been processed is archived.

This abort or only partial processing (execution) can occur due to a non-assignable token reference. For example, there was never an assignable token (fraud attempt) or the assignable token has already been modified again and a token reference exists in the token reference register for this modification (split, merge, switch) or the assignable token has already been issued (illegal multiple issue attempt) or the assignable token has been deleted (token value has been redeemed). In order to be able to map and resolve this event of an error, the archiving unit is provided in which the part of the sequence that has already been processed is archived.

The memory unit of the token reference register has been updated in an incomplete manner in all these aborts or only partially processing (executions) of a sequences of registration requests, and, for complete processing of the sequence of registration requests when the registration of the sequence is repeated, the archiving unit is now provided in order to detect any attempts at manipulation (e.g. modification of the sequence by the subscriber unit).

The division into a first part (=passive part) and a second part (=active part) in the archiving unit makes it easier to resume the processing of an incompletely processed sequence, as registration requests for incompletely processed sequences can be processed in the second part.

The token reference register can now easily detect the registration request of the sequence of registration requests received again or repeatedly with the cooperation and calling of the archiving unit and finally process the sequence completely.

If the sequence of registration requests is fully processed, it can be restored from the first part to the second part of the archiving unit.

The first part of the archiving unit can also be called by the token reference register if a token reference is not stored in the token reference register in order to ensure that this token reference is not part of an incompletely processed sequence.

The first part of the archiving unit can also be called by an instance of the transaction system if a token is to be deleted or redeemed. This instance can then use an assignable token reference to ensure whether the token was part of an incompletely processed sequence of registration requests.

In a preferred embodiment, the token references of the sequence of registration requests are verified chronologically backwards. For example, a registration response is generated for the last successfully verified registration request or all successfully verified registration requests in the sequence of registration requests. This registration response can then be additionally signed with the private part of the key pair of the token reference register. The registration response is sent to the subscriber unit or the registration request unit as confirmation of the registration.

Once the last registration request in the sequence has been successfully verified and this has been sent to the subscriber unit or registration request unit as confirmation (registration response), all registration requests in the sequence can be deleted in the subscriber unit.

A token is a data set of a transaction system that can be directly exchanged between subscriber units. With knowledge of the token, the receiving subscriber unit is in possession of the token value that the token represents. With the exchange, the token accordingly automatically changes owner. A token—a data set that is transmittable independently of a transaction topology, such as blockchain topologies “Bitcoin”, “Ethereum”, or “Neo”—can be transmitted directly between subscriber units without intermediary units.

In one embodiment, the token is an electronic coin data set or payment token for exchanging monetary values between subscriber units. In colloquial terms, such a payment token is also referred to as a “digital coin” or “electronic coin” and represents cash in electronic form.

Each token in the transaction system is a data set comprising at least two token elements.

A first token element of each token of the transaction system is a token value, for example an asset value, an asset, a commodity, and/or a monetary value.

A second token element of each token of the transaction system is a private part of a token-individual key pair. This private part is a secret in the transaction system and is not published and may not be used multiple times. The creation of the private part must not be predictable. This private part can be a random number. The random number is preferably the result of a true random generator.

The token is formed from the token value (first token element) and the private part. This formation is preferably the chaining (concatenation) of these two token elements. Any other type of chaining of these two token elements is not excluded according to the invention and includes, for example, back-end attachment, introduction into a TLV data structure and/or logical chaining.

The token differs from a data set for classic data exchange or data transfer, as classic data exchange is based on a question-and-answer principle or on intercommunication between the partners in the data exchange, for example. A token, on the other hand, is singular and unique in the transaction system. The token is part of a security concept that comprises signatures or cryptographic encryption, for example. A token contains all the data elements required by a receiving subscriber unit for verification, authentication, and forwarding the token to another subscriber unit. Intercommunication between the subscriber units transmitting a token is therefore generally not required for a token.

Anyone who is in possession of a token or has unrestricted access to the token with its token elements can exchange this token with another subscriber unit. The possession of the token with its at least two token elements (token value and private part of the token-individual key pair) is thus equivalent to the possession of the value representing the token.

A token reference is assigned to each token in the transaction system. This assignment is unique, i.e. one token reference is assigned to precisely one token, and each token reference is assigned precisely one token. The token reference is a public data set which is stored, such that it can be reviewed, in a memory unit of the token reference register of the transaction system for each subscriber unit.

Both the token and the token reference are unique. Due to the unique assignment, there is a 1-to-1 relationship between the token and the token reference.

Each token reference in the transaction system is a data set comprising at least two token reference elements.

A first token reference element of each token reference is the token value of the token uniquely assigned to the token reference. The token value of the token is thus identical to the token value of the assigned token reference. For example, the token value of the token reference is a copy of the token value of the assigned token.

A second token element of each token reference of the transaction system is a public part of the token-individual key pair. Together with the private part of the token, this public part of the token reference forms the token-individual key pair. The public part is obtained by applying a cryptographic function to the private part.

This cryptographic function is a one-way function. This cryptographic function is accordingly a mathematical function which can be calculated “easily” in terms of complexity theory, but is “difficult” up to virtually impossible to reverse. In this case, a one-way function also denotes a function for which, hitherto, a reversal that is practically executable within a reasonable time and with reasonable effort has not been known. Preferably, a one-way function is used which operates on a group in which the discrete logarithm problem is difficult to resolve, such as a cryptographic method analogous to an elliptical curve encryption, for short ECC, from a private key of a corresponding cryptography method. The reverse function, i.e. the creation of a token (or the part of the electronic coin data set) from a token reference, is very time-consuming here.

The (mere) knowledge or the possession of a token reference does not afford the right to use/transmit/output the token value (token reference element). This represents a substantial difference between the token reference and the token and is a core of the present invention.

After the cryptographic function has been applied to the private part of the token-individual key pair, the public part of the token-individual key pair is obtained as the second token reference element.

The token reference is formed from the token value (first token reference element) and the public part. This formation is preferably the clinking (concatenation) of these two token reference elements. Any other type of chaining of these two token reference elements is not excluded according to the invention and includes, for example, back-end attachment, introduction into a TLV data structure and/or logical chaining.

A token reference can preferably be created by an electronic wallet of a subscriber unit. For this purpose, the subscriber unit must have knowledge of the token with its token elements. The token reference can be created by an electronic wallet of a subscriber unit that wishes to send the token. Alternatively, the token reference can be created by an electronic wallet of a subscriber unit which has received the token.

The use of a token reference is not comparable to the use of addresses of subscriber units in a blockchain-based transaction system, since no addresses of the subscriber units are used in the token reference register according to the invention in order to prevent the possibility of the tokens being tracked.

The method for registering provides a receiving step in order to receive a token reference in a token reference register within the scope of a registration request.

For example, the registration request is sent by a subscriber unit of the transaction system or a token issuer of the transaction system.

The token reference register is a unit of the transaction register that stores the token references, whereby the assignable tokens are registered. This register can be a central database or memory unit. This register can be a decentralized ledger, for example in a blockchain topology. The token reference register can maintain a history of the token references and/or the registration requests.

The received registration request is verified by a verification unit in the token reference register. In this case, it is verified whether the at least one token reference of the received registration request is already stored in the token reference register.

In the token reference register, a token reference is only stored once. Since a token reference of a token is present only once in the transaction system, it can be established by the verification step whether an attempt has been made to output a token several times.

In one embodiment, in the verification step, using the verification unit of the token reference register, it is also established whether the token reference in the received registration request can be uniquely assigned to a token. For this purpose, the token reference or a derivation of the token reference or a history (archive) for the token reference must be stored in the token reference register (e.g. the archiving unit), which can be assigned to the token reference of the received registration request.

In one embodiment, in the verification step, it is established whether the received registration request is syntactically correct. For example, it is thus checked whether the registration request is plausible, whether a command type was correctly indicated in the registration request, whether the token which is uniquely assigned to the token reference is actually present (can exist); and/or whether a difference formation of token values in the registration request matches a command type specified in the registration request.

In one embodiment, in the verification step, it is established whether a signature of the registration request is correct.

In one embodiment, in the verification step, it is also determined whether a sum of token values of all token references within the registration request is zero. In this case, input token values and output token values of the registration request are summed. In the case of registration requests originating from subscriber units, a sum of all token values of the registration request must give zero. If the sum does not give zero, a token value will have additionally been created inadmissibly in the transaction system or a token value will have been destroyed from the transaction system. A fraudulent attempt with a non-existing token or a token generated inadmissibly can thus be detected more easily. Until now, complex range references (zero-knowledge-proofs, ZKP) have been necessary, which can be omitted by this method.

The received token reference is stored in a memory unit of the token reference register. The memory is used to register in the transaction system the token uniquely assigned to the received token reference. The storage process takes place only if it is determined in the verification step that the at least one token reference of the received registration request is not stored in the token reference register.

The basic principle of registering a token is therefore that a received registration request is verified to determine whether the token reference assigned to the token is already known in the token reference register. If the token reference is already known, it will not be stored again. If the token reference is not known, it will be entered (stored) into the token reference register in order to be available in the transaction system for future verification and checking steps.

In one embodiment, the received registration request is signed with the private part of the token-individual key pair in order to be able to check or verify an assignment of the token reference to the token. If the verification in the verification step is successful, i.e. the signature can be verified, then the sender of the registration request must be in possession of the token or have the knowledge of the token. A fraudulent attempt with a non-existing token or a token generated inadmissibly can thus be detected.

In one embodiment, the token reference is obtained by masking the assigned token by applying a homomorphic one-way function to the token.

In one embodiment, the token reference register has one or more memory units for storing token references for registering the tokens in the transaction system.

This (these) memory unit(s) can be maintained as a central database of the transaction system. The use of multiple memory units—analogous to the use of multiple verification units—enables parallel processing of registration requests and speeds up registration in the transaction system.

The verification unit(s) compares (compare), for example, a command type of the received registration request with the token values of the received registration request. If command type expects that no token values are to be added to or subtracted from the transaction system, it is checked whether this is adhered to with the token values of the received token references. If verification fails, a case of fraud is detected and registration is prevented.

In one embodiment, the token reference register has a check unit for checking a sum of token values relating to the received registration request. This check unit compares the received registration request with a data inventory of the memory unit and checks in particular a total sum of all token values for changes due to the registration request. The validity of the token value can thus be checked to determine whether a new token value was generated inadmissibly. This would also allow old registration requests and their success to be checked; this registration request history could be used to process registration requests sent twice without burdening the memory unit of the token reference register.

In one embodiment, the token reference register has a new registration unit in order to register token references to newly created tokens (=new tokens) or deleted tokens (deactivated tokens) of a token issuer. These newly created tokens and these deleted tokens can be entered in this new registration unit of the token reference register. The new registration unit can be used to update a reference value relating to the total token value of the tokens present in the transaction system on the basis of the created and/or deleted tokens in the token reference register (for example in a check unit thereof). If, for example, a new token is generated, then its token value will be added to the total token value. If, for example, a token is deleted, then its token value will be subtracted from the total token value.

In one embodiment, the token reference has at least one count value as a further token reference element and/or the token has a count value as a further token element. The count value can represent, for example, the number of off-line transactions of the token. The count value can be greater than the number of registration requests in the sequence. An off-line transaction in this case is a direct transaction between subscriber units in the transaction system for transmitting tokens, without the token being registered in the token reference register. The count value increases (increments) with each off-line transaction. It can be provided, in a manner determined by the system, that tokens must be registered automatically in the token reference register when a predefined threshold value for the count value is exceeded.

In one embodiment, the token reference has at least one identity of a subscriber unit or of an owner of the subscriber unit as a further token reference element. The identity can be a further token element. This identity is used in the check step, for example, to validate or verify the token reference. This removes the anonymity in the transaction system and a case of fraud is detected more quickly.

In one embodiment, the token reference has at least one pseudonym of a subscriber unit or of an owner of the subscriber unit as a further token reference element. The pseudonym can be a further token element. This pseudonym is used in the checking step, for example, to validate or verify the token reference. This does not remove the anonymity in the transaction system and a case of fraud is still detected more quickly if a unit of the transaction system resolves the pseudonym.

In order to create the token reference, each further token reference element can be added by a chaining (concatenation) with the first and/or second token reference elements.

In one embodiment, the registration request relates to a splitting of a token, and preferably the registration request comprises a token reference of the token to be split and a token reference of each of the (at least two) split tokens. The token references contained in the registration request can be joined together by chaining (concatenation). The split is a possibility of modification on a token with which a token value of a token can be split into at least two (smaller) token values. It is thus possible to reduce the token value and to react to a transaction request more accurately in terms of token value. The split token is thus invalid and the (at least two) split tokens are registered in the token reference register in order to be checked in the transaction system.

Alternatively or additionally, it is provided for the split that the token value of the token to be split is split into at least one first token value and into one second token value. The split can take place symmetrically, so that the split token values are of equal size. The split can take place asymmetrically, so that the split token values are different.

Alternatively or additionally, the following steps are provided during the split: creating a new private part of a token-individual key pair for a first split token; applying a cryptographic function to obtain a corresponding public part of the token-individual key pair for the first split tokens; creating a new private part of a token-individual key pair for a second split token; applying a cryptographic function to obtain a corresponding public part of the token-individual key pair for the second split token; splitting the token value into a first token part value and into a second token part value, taking into account that the sum of the first token part value and the second token part value corresponds to the token value of the token to be split; creating a token reference for the first split token comprising the first token part value and the public part of the token-individual key pair of the first split token; creating a token reference for the second split token comprising the second token part value and the public part of the token-individual key pair of the second split token; and generating the registration request using the token reference of the token to be split, the token reference for the first split token and the token reference for the second split token.

In one embodiment, the registration request relates to a switching of a token and preferably the registration request has a token reference of the token to be switched. The switching of the token is a further modification possibility. The token references contained in the registration request can be joined together by chaining (concatenation). If a token is transmitted by a subscriber unit directly to another subscriber unit, for example if the monetary value is to be transmitted as a token value within the scope of a payment transaction, the receiving subscriber unit can now have the token value re-registered to itself. The switching is thus registered in the token reference register.

When a token is transmitted between two subscriber units, these two subscriber units will simultaneously have knowledge of the token. In order to prevent the sending subscriber unit from also using the token in another (third) subscriber unit (so-called multiple output of the token), a switch of the transmitted token from the first subscriber unit to the second subscriber unit is preferably carried out. The switch can preferably take place automatically when a token is received in the second subscriber unit.

Alternatively or additionally, the following steps are provided during the switch: creating a new private part of a token-individual key pair; applying a cryptographic function to obtain a corresponding public part of the token-individual key pair; generating the registration request using the token reference for the token to be switched and the public part of the token-individual key pair for the switched token.

The token value of the token to be switched corresponds to the token value of the switched token. During the switch, a token having the same token value but a new private part is accordingly registered in the token reference register.

In one embodiment, the registration request relates to a merging of at least two tokens, and the registration request preferably has a token reference of the merged token and a token reference of each of the tokens to be merged. The token references contained in the registration request can be joined together by chaining (concatenation). The merge is a possibility for modification at a token, with which two token values are merged, that is to say, linked to one another. It is thus possible to fuse two token values into one token value in order to react to a transaction request accurately in terms of token value. The tokens to be connected are thus invalid and the connected token is registered in the token reference register in order to be checkable in the transaction system.

Alternatively or additionally, the following steps are provided during the merging: creating a new private part of a token-individual key pair; applying a cryptographic function for obtaining a corresponding public part of the token-individual key pair for the merged tokens; calculating the token value for the merged token by forming the sum of the respective token values of the at least two tokens; creating a token reference for the merged token comprising the calculated token value and the public part of the token-individual key pair for the merged token; and generating the registration request using each token reference of the tokens to be merged and the token reference for the merged token.

In one embodiment, a registration request is sent by a token issuer, with the registration request relating to a generation of a token or a deletion of a token.

In contrast to a subscriber unit, a token issuer is a privileged entity in the transaction system, which can be created by the tokens and deleted. A subscriber unit cannot create or delete tokens, it can only modify tokens (switch, split, merge).

The token is stored in a token memory to which the subscriber unit has exclusive access. This token memory may have a plurality of tokens, for example, the plurality of tokens may be stored in a data memory of the subscriber unit. The data memory can be, for example, internal, external or virtual. In one embodiment, a “merge” can automatically take place when a token is received, so that preferably only one (or a certain number of) tokens are stored in the subscriber unit.

The subscriber unit can be, for example, a mobile terminal, such as a smart phone, a tablet computer, a computer, a server or a machine. The subscriber unit may be a smart card that is introduced ready for operation in a terminal.

The data memory is, for example, a wallet memory of an electronic wallet. The electronic wallet is, for example, a software application which is stored executably in a subscriber unit. The electronic wallet can enable the subscriber unit to participate in the transaction system. The electronic wallet can thus generate a registration request in order to register a token in a token reference register. In addition, the electronic wallet can carry out modifications (switching, merging, splitting) on a token and can generate the registration requests that are possibly necessary and transmit them to the token reference register. In addition, the electronic wallet can transmit tokens to another wallet (in another subscriber unit).

A transaction in the transaction system is preferably atomic.

The token reference register accordingly has knowledge about token references of tokens of the transaction system and preferably also maintains the processing operations or modifications to the token (token history). The transactions with the token are not registered in the token reference register and take place directly between subscriber units of the transaction system in a direct transaction layer of the transaction system.

According to the invention, a token reference register for a transaction system is provided which is configured to carry out the method steps according to the method described above.

In one embodiment, the token reference register comprises: at least one memory unit for storing token references for registering tokens in the transaction system; at least one verification unit for verifying whether a token reference of a received registration request is stored in the token reference register; an archiving unit for storing sequences of registration requests; and/or a new registration unit for registering tokens newly generated by a token issuer or tokens deleted by a token issuer.

In a preferred embodiment, the memory unit is configured such that a subscriber unit or a registration request unit only has write access to the memory unit, and/or the archiving unit and/or the verification unit has read and write access to the memory unit.

The separation of the token reference register into a memory unit (no read access for a subscriber unit) and verification unit (with read and write access to the memory unit) enables registration requests to be processed quickly. This means that the memory unit can be updated on the basis of a registration request, while a verification unit can read the memory unit for this purpose. The token reference register can be present in a DLT architecture or be designed as a central register with, optionally, a plurality of verification units working in parallel and, optionally, a plurality of memory units working in parallel.

The token reference register is configured for receiving a plurality of registration requests, which are verified in parallel in a plurality of verification units to determine whether the at least one token reference contained in the respectively received registration request can be uniquely assigned to a token of the transaction system, with all registration requests of a sequence of registration requests being verified sequentially one after the other in the same verification unit. This allows the verification unit(s) to process individual registration requests, registration request batches or even sequences of registration requests, whereby the above-mentioned “load balancing” can be enabled. The sequences of registration requests can be processed sequentially. The verification unit does not need to know whether the received registration request is part of a sequence of registration requests.

According to the invention, a transaction system is provided which comprises a register layer with a token reference register of the preceding type for registering token references, and a direct transaction layer with a plurality of subscriber units, configured for the direct exchange of tokens among one another.

According to the invention, a two-layer transaction system is thus provided from a direct transaction layer for the direct exchange of tokens and a register layer. In the register layer, no transactions are logged, but only token references are stored, and modifications to tokens are stored via correspondingly adapted token references for the purpose of verifying the validity of tokens. The anonymity of the subscribers of the transaction system is thus ensured. On request, the token reference register provides information about the token references which are uniquely associated with the tokens of the transaction system in order, for example, to prevent a multiple output of the same token or to verify the authenticity of the token.

The memory unit of the token reference register preferably only stores token references of tokens actually present in the transaction system. Once a token is modified and a corresponding (modified) token reference is to be registered, the (old) token references become invalid and (only) the modified token references are stored in the memory unit.

In one embodiment, old (i.e. invalidated) token references are deleted from the memory unit and archived in a token reference archive. The token reference archive can be part of the archiving unit, but it can also be provided as a separate unit in the token reference register or in the transaction system. The token reference archive can also be completely replaced by the archiving unit if all registration requests are completely stored there. The time-dependent deletion of registration requests can also apply to the deletion of old token references.

According to the invention, a subscriber unit is also provided in a transaction system comprising: an interface which is configured for transmitting tokens to another subscriber unit and sending, to a token reference register or a registration request unit of the transaction system, a registration request from a sequence of registration requests, each registration request containing at least one token reference.

In addition, the subscriber unit has access means to a token memory and/or the subscriber unit has a token memory, with at least one token of the subscriber unit being stored with the sequence of registration requests in the token memory.

In addition, the subscriber unit has a computing unit which is configured for applying a cryptographic one-way function to a private part of a token-individual key pair of a token of the token memory for obtaining a token reference; and for modifying tokens. Modifying tokens comprises, in particular, splitting tokens, linking tokens, and/or switching tokens as described above.

The subscriber unit can be configured such that only one token is stored in its token memory. This token is divided (SPLIT) for direct transactions in order to create a correct token value corresponding to the transaction to be carried out. If tokens are received in the subscriber unit, the received token is immediately linked (MERGED) to the token in the token memory.

For transmitting a token to another subscriber unit, this token of the token memory can therefore be divided (SPLIT), with a registration request being created for this purpose. Preferably, the registration request has a token reference of the token to be split and a token reference of each of the split tokens.

When receiving a token from another subscriber unit, the received token is merged to the token in the token memory, with a registration request being created for this purpose. Preferably, the registration request has a token reference of the merged token and a token reference of each of the tokens to be merged.

A subscriber unit can, in the present case, be a secure element which has secure access to tokens in a token memory. The secure element is, for example, introduced ready for operation in a terminal. The secure element and/or the terminal have a special computer program product (electronic wallet), in particular in the form of a secured runtime environment within an operating system of a terminal (trusted execution environment, or TEE), which is stored on a data memory, for example of a mobile terminal, a machine, preferably an ATM. Alternatively, the secure element is designed, for example, as special hardware, in particular in the form of a secured hardware platform module (trusted platform module, or TPM), or as an embedded security module, eUICC, eSIM. The secure element provides a trusted environment.

The communication between the terminal and the secure element as a subscriber unit can take place by means of APDU. The communication between terminal and token reference register or issuer unit can take place by means of API calls. The terminal is only a protocol translator and does not change the registration requests.

The communication between two subscriber units for exchanging tokens can take place wirelessly or by wire, or for example also on an optical path, preferably via QR code or barcode, and can be designed as a secure channel. The exchange of tokens is, for example, additionally protected by cryptographic keys, for example a session key negotiated for a token exchange or on the basis of a subscriber-unit-individual key pair.

### BRIEF DESCRIPTION OF THE DRAWINGS

The invention and further embodiments and advantages of the invention will be explained in more detail below with reference to figures, wherein the figures merely describe exemplary embodiments of the invention. Identical components in the figures are provided with the same reference numbers. The figures are not to be considered true to scale; individual elements of the figures may be illustrated excessively large or excessively simplified.

FIG. 1 shows an exemplary embodiment of a transaction system according to the invention;

FIG. 2 shows an exemplary embodiment of a token reference register according to the invention;

FIG. 3a shows an overview of commands for tokens according to the invention;

FIG. 3b shows an overview of signed registration requests according to the invention for the commands according to the invention;

FIG. 4 shows an exemplary embodiment of a flowchart of a method according to the invention for generating and registering a token and an overview of the command details in dependence on the transaction layer;

FIG. 5 shows an exemplary embodiment of a flowchart of a method according to the invention for deleting a token and registration;

FIG. 6 shows an exemplary embodiment of a flowchart of a method according to the invention for splitting and registering a token, and an overview of the command details in dependence on the transaction layer;

FIG. 7 shows an exemplary embodiment of a flowchart of a method according to the invention for merging and registering a token, and an overview of the command details in dependence on the transaction layer;

FIG. 8 shows an exemplary embodiment of a flowchart of a method according to the invention for switching and registering a token, and an overview of the command details in dependence on the transaction layer; and

FIG. 9 shows a further exemplary embodiment of a token reference register according to the invention.

### DETAILED DESCRIPTION OF VARIOUS EMBODIMENTS

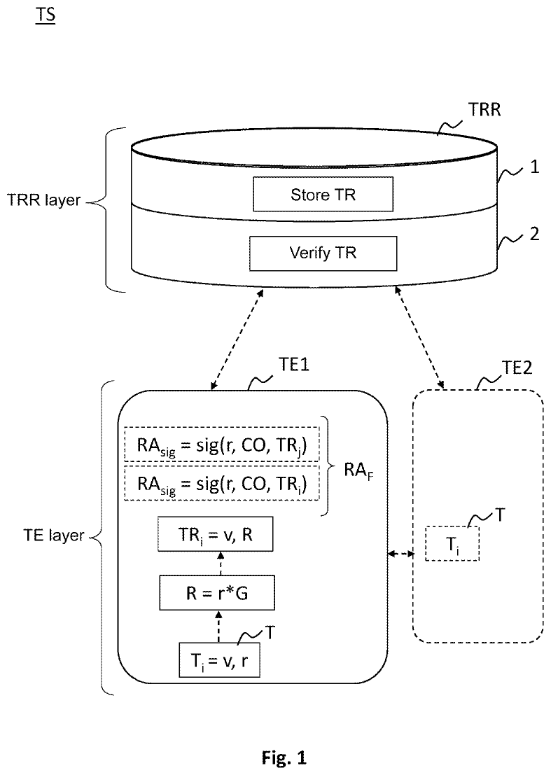

FIG. 1 shows an exemplary embodiment of a transaction system TS according to the invention. The transaction system TS comprises a register layer, TRR layer, in which a token reference register TRR is arranged. The TS also comprises a direct transaction layer TE layer in which a plurality of subscriber units TE can be provided, representatively with two subscriber units TE1, TE2.

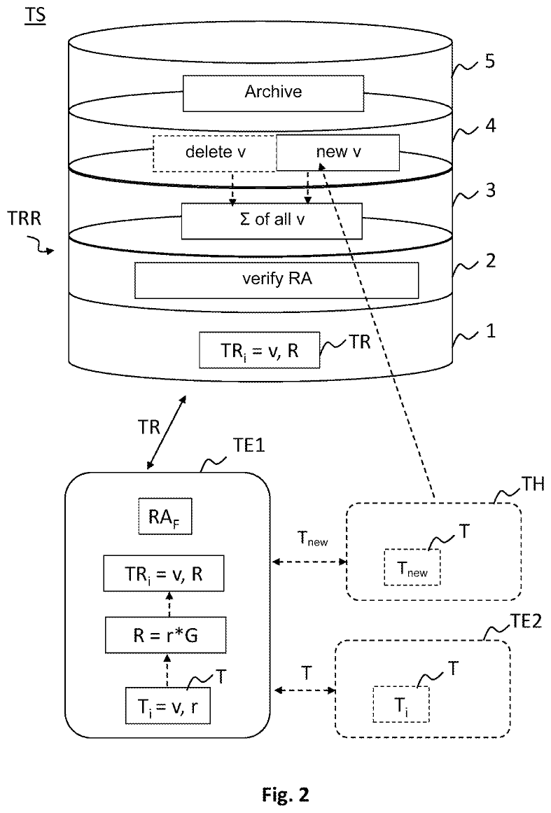

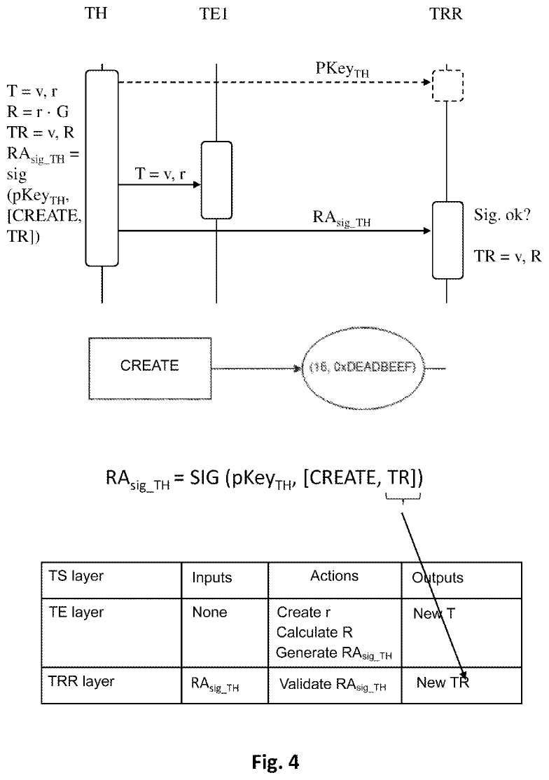

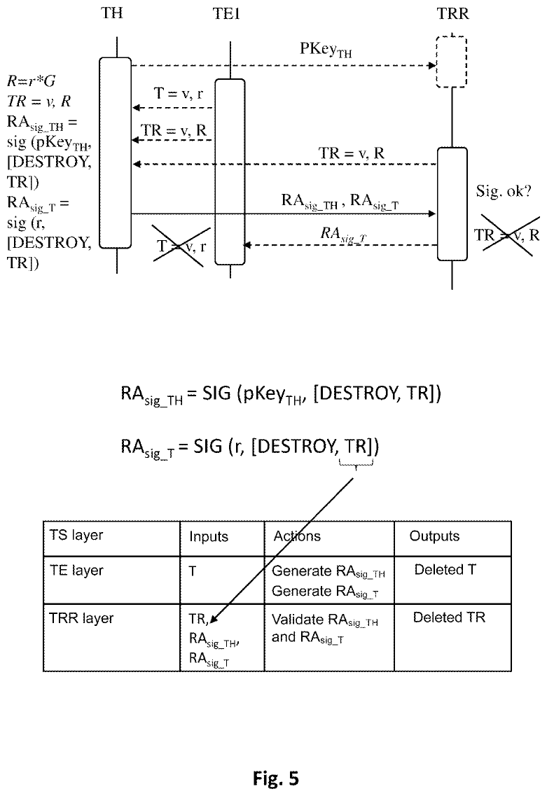

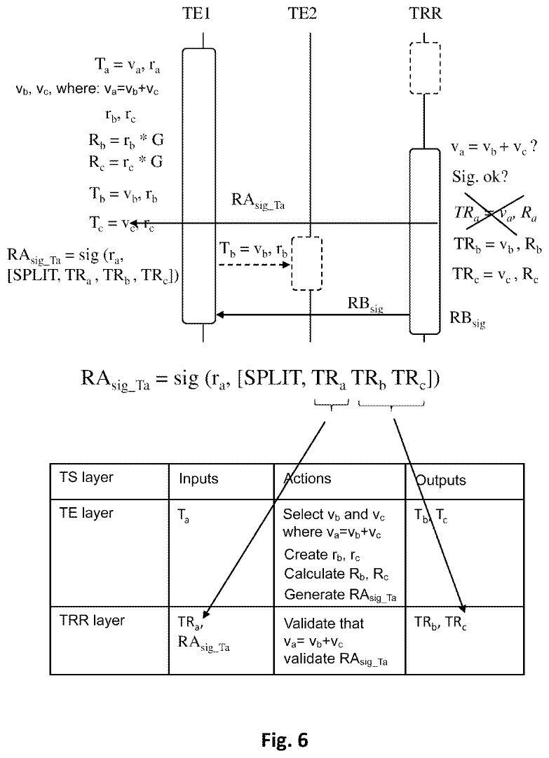

The subscriber units TE of the transaction system TS are configured to exchange tokens T directly amongst one another. In the case of FIG. 1, the tokens are payment tokens, which are also referred to as digital coins. Each token T is generated by a token issuer TH (not shown in FIG. 1; see FIG. 2). Each token T can be modified by each subscriber unit TE, i.e. split, merged or switched (see FIGS. 6 to 8) and can be generated by the token issuer TH (see FIG. 4) and also deleted (see FIG. 5). A token issuer TH is, for example, a central bank.

A token T is uniquely represented in the transaction system TS by a token value v and a random number r as token elements. The token value v can be given in a value range from 1 to 2³¹-1. The random number r can be a number in the range from 0 to 2²⁵⁶-1, i.e. the order of an elliptical curve, for example secp256r1.

The random number r is a private part of a token-individual key pair. The random number r is unique and secret in the transaction system TS and cannot be published or re-used. The creation of the random number r may be unpredictable.

For example, the token value v is a 32-bit token element of the integer type. For example, the random number r is a 32-byte token element of the integer type. A subscriber unit TE has exclusive access to this token memory or comprises this token memory in a data memory of the subscriber unit TE.

A token can be stored as a TLV-encoded data set in a token memory and then has a unique tag and length information, for example in the following format.

| | Day | | Token | Random |
|---|---|---|---|---|
| Name | (hex) | Length | value v | number r |
| TLV-encoded token | 42 | 1 byte | 4 bytes | 32 bytes |

An example of a TLV-encoded token in hexadecimal form is shown below:

### 42 24 00 00 40 00 00 01 02 03 04 05 06 07 08 09 0A 0B 0C 0D 0E 0F 10 11 12 13 14 15 16 17 18 19 1A 1B 1C 1D 1E 1 F

and is interpreted as follows:
“42” is the tag for identifying the TLV-encoded token T;
“24” specifies the length, i.e. in this case that it is a 36-byte data set;
“00 0040 00” is the token value (integer) v=16384 and is accordingly €163.84;
“00 01 02 03 04 05 06 07 08 09 . . . 1D 1E 1F” is the random number r as an integer.

A token reference TR can be stored in the token reference register TRR for each token T. The token reference TR comprises the token value v of the assigned token T and a public part R of the token-individual key pair. The token reference TR of the token T can be viewed at any time in the register TRR of the transaction system TS. The token value v of a token T is thus disclosed by the token reference register TRR.

The public part R of the token-individual key pair is created by applying a cryptographic function to the private part r of the token-individual key pair. This function is difficult to reverse and thus gives the transaction system TS the available security. R=r*G, where G can, for example, be a global parameter of the transaction system TS, for example a generator point of an elliptical curve, here the secp256r1 curve.

The token reference TR is then formed by the token value v of the token and the public part R of the key pair. The token reference TR is therefore the link or chaining of token value v and public part R.

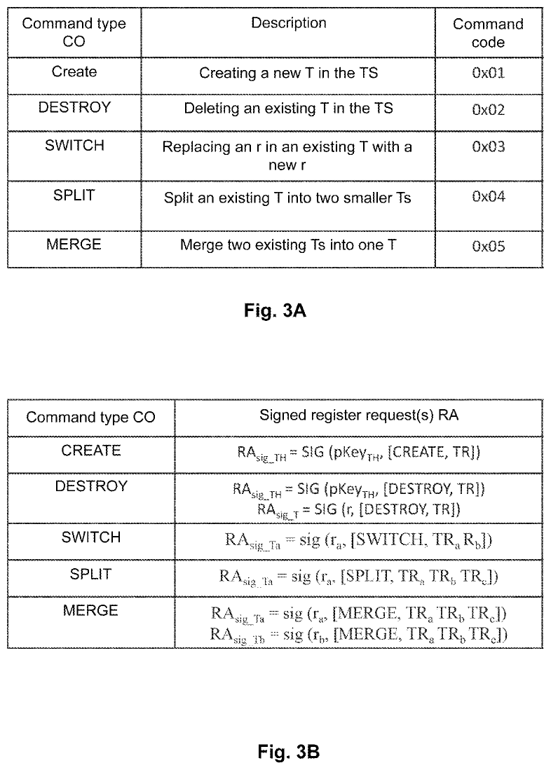

This token reference TR can be sent as a registration request RA, optionally together with a command (see overview in FIGS. 3a and 3b) with respect to the token T to the token reference register TRR.

In addition, the registration request RA can be signed with the private part r of the token-individual key pair. The signing makes it possible to verify whether the transmitter of the token reference TR was in possession of the token T, whereby the security in the transaction system TS is further increased.

In the subscriber unit, the signed registration request RAsig is stored as a so-called PROOF, for example in the following format:

| Type | Day (hex) | Length | Data |
|---|---|---|---|
| PROOF | 4A | N bytes | |

An example of a PROOF (=RA_{sig}) in hexadecimal form is shown below:

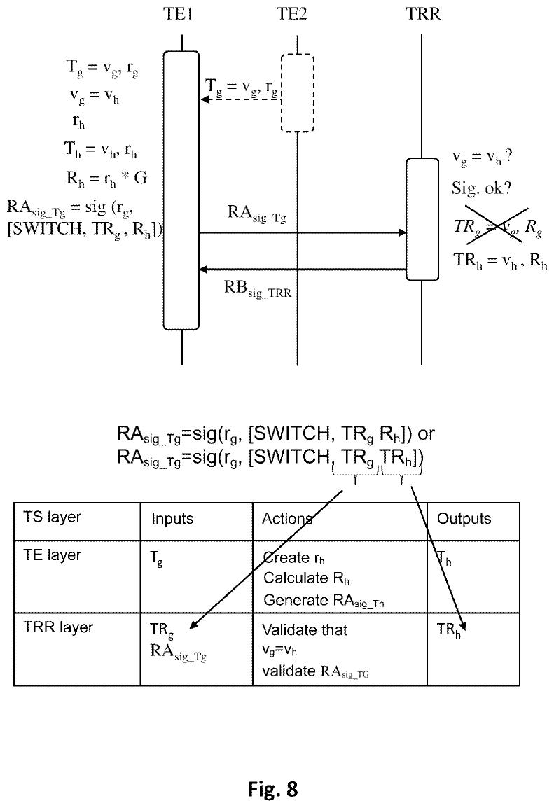

4A 81 8 F 03 11 12 13 14 15 16 17 18 19 1A 1B 1C 1D 1E 1 F 20 21 22 23 24 25 26 27 28 29 2A 2B 2C 2D 2E 2 F 30 31 32 33 34 35 36 37 38 39 3A 3B 3C 3D 3E 3F 40 41 42 43 44 45 46 47 48 49 4A 4B 4C 4D 4E 4 F 50 51 52 53 54 55 56 30 46 11 12 13 14 15 16 17 18 19 1A 1B 1C 1D 1E 1 F 20 21 22 23 24 25 26 27 28 29 2A 2B 2C 2D 2E 2 F 30 31 32 33 34 35 36 37 38 39 3A 3B 3C 3D 3E 3F 40 41 42 43 44 45 46 47 48 49 4A 4B 4C 4D 4E 4 F 50 51 52 53 54 55 56
and is interpreted as follows (see also FIG. 8 regarding the structure of a switch registration request):
“4A” is the tag for identification of the TLV-proof RA_{sig_Th},
“81 8F” gives the length;

“03” indicates that this is a switch (=SWITCH) registration request;

“11 12 13 14” is the token value v_{g};

“15 16 17 18 19 1A 1B 1C 1D 1E 1F 2021 22 23 24 25 26 27 28 29 2A 2B 2C 2D 2E 2F 30 31 32 33 34 35” is the public part R_{g};

“36 37 38 39 3A 3B 3C 3D 3E 3F 40 41 42 43 44 45 46 47 48 49 4A 4B 4C 4D 4E 4F 50 51 52 53 54 55 56” is the public part Rₕ;
“30 46 11 12 13 14 15 16 17 18 19 1A 1B 1C 1D 1E 1F 20 21 22 23 24 25 26 27 28 29 2A 2B 2C 2D 2E 2F 30 31 32 33 34 35 36 37 38 39 3A 3B 3C 3D 3E 3F 40 41 42 43 44 45 46 47 48 49 4A 4B 4C 4D 4E 4F 50 51 52 53 54 55 56” is the signature as X690 sequence.

This registration request RA can be sent to the token reference register TRR. This registration request RA is received in the token reference register TRR. After checking the registration request RA by the token reference register TRR, the token reference TR is stored in the token reference register TRR, whereby the token T is registered in the transaction system TS.

The token reference TR is uniquely assigned to the token T and is used to register the token T in the transaction system TS. The token reference TR is accordingly the public representation of the token T from the direct transaction layer TE layer. The sole knowledge or only the possession of the token reference TR does not allow the token T to be transmitted and is not equivalent to the TE being in possession of the token T. The token reference TR serves to prevent multiple output attempts and checks whether token values v have been generated inadmissibly. For this reason, the token reference TR and, if applicable, the history via the tokens T and the corresponding registration requests RA from subscriber units TE are stored in the token reference register TRR.

The tokens T are stored, for example, in token memories or electronic purses, so-called wallets, of a TE. These wallets are, for example, software applications within the subscriber units TE or a terminal in which the TE is introduced ready for operation. A wallet can be configured as an application on a smart phone, a smart card, or a payment terminal. The wallet serves to securely manage tokens T of the TE, to create token references TR, to modify tokens T and/or to exchange tokens T. Wallets serve to communicate with the token reference register TRR, to generate registration requests RA to the token reference register TRR and/or to carry out transactions of tokens T relative to a subscriber unit TE.

For a transaction with a subscriber unit TE, it is not necessary for there to be a communication link to the token reference register TRR of the transaction system TS. The transaction system TS is configured to carry out a transaction off-line, i.e. without a communication link to the token reference register TRR. A corresponding registration of tokens T can therefore be temporally downstream of a transmission of the token T to a subscriber unit TE.

The token reference register TRR is a unit of the transaction system TS and is either a central register or a central database of the transaction system TS or a decentralized register or a decentralized database (DLT) of the transaction system TS.

Transmitting a token reference TR from an electronic wallet takes place, for example, as (an) APDU command(s) to a terminal device (smartphone) as subscriber unit TE. An APDU is a combined command/data block of a connection protocol between the secure element and the terminal. The structure of the APDU is defined by the ISO 7816-4 standard. The terminal device extracts APDU command(s) and transmits the data in API calls to the token reference register TRR, where HTTP codes are implemented.

FIG. 2 shows an exemplary embodiment of a token reference register TRR of the invention.

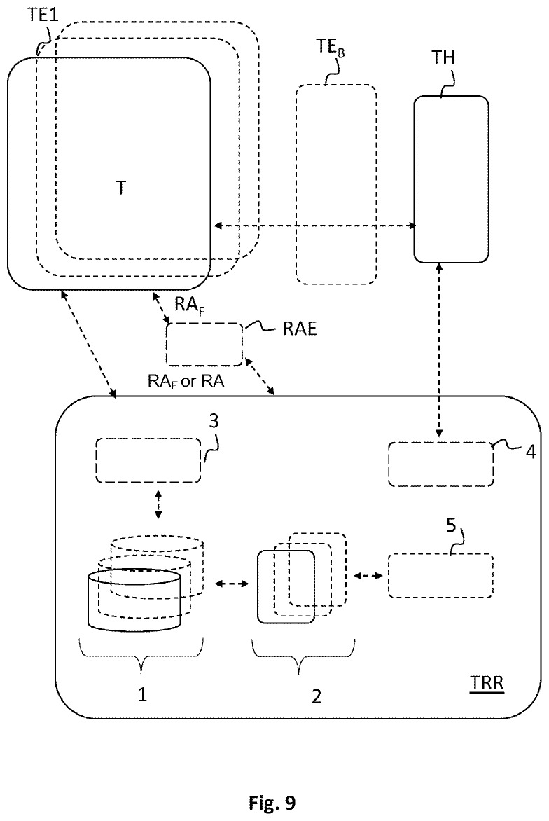

The token reference register TRR manages in particular the storage location for the token references TR, here as a database 1 as an example of a memory unit in the token reference register TRR. As a representative, the TR for the token T of the subscriber unit TE1 is entered in the database 1. This database 1 can consist of a combination of many databases (see also FIG. 9), which are networked with one another. For simple finding of a token reference TR, the public part R of the token reference TR is simultaneously a database index in the database 1, since both an index of a database and a public part R of a token reference TR must be unique in the transaction system TS.

In addition, the token reference register TRR can comprise at least one verification unit 2. The verification unit 2 of the token reference register TRR verifies registration requests RA. A syntactic correctness or also the correct indication of a command in the registration request RA can be verified here. In particular, the registration request RA can be checked for value neutrality. A history of old (past) registration requests RA regarding a token T can also be verified in this case. The separation of this verification unit 2 from the database 1 distributes the tasks of storing and checking and increases the speed in the token reference register TRR.

In addition, the token reference register TRR may comprise a check unit 3 which checks whether (for example with the token value v of a received token reference TR) a total token value 2 is changed in the transaction system TS. The check unit 3 compares a total reference value with the actual sum of the token values stored in the database 1. If this is the case, a new token value v has been created or an existing token value v has been destroyed. Only privileged units, such as an issuer instance TH, may do this in the transaction system TS. If such a change in the total sum of the token values is detected by a token reference TR of a subscriber unit TE, then a case of fraud can be assumed. An illegal generation of token values v can thus be discovered and prevented very easily.

The check of the total token value by the verification unit 3 represents a further security concept in the transaction system TS.

In addition, the token reference register TRR can comprise a new registration unit 4, into which newly generated token references TR of a token issuer TH are first registered or token references TR to be deleted are de-registered. A functional separation between token references TR of privileged subscribers, such as a token issuer TH, and token references TR of unprivileged subscribers, such as the subscriber units TE, is thus achieved. The token values v of newly generated token references TR or token references TR to be deleted have a direct influence on a change in the total token value, which is monitored in the check unit 3. The total reference value is adjusted accordingly when the token issuer first registers or de-registers the TH token.

A registration request RA is preferably signed with the private part r. The signature allows the syntactic authenticity of the command to be easily checked by the recipient (TRR or TE). This check is preferably carried out in database 1 or verification unit 2. In addition, a registration request RA can, for example, be validated syntactically by checking the signature and/or the token reference TR.

Even when a signature can be checked in a subscriber unit TE, it is thereby not ensured that no multiple output of the same token T has been attempted. The registration in the token reference register TRR is therefore provided. In addition, a secure hardware platform is kept available by the subscriber units TE. With available connection to the token reference register TRR, the token references TR are transmitted and the multiple output attempt can be discovered in the token reference register TRR.

If a token reference TR is not yet known in the token reference register TRR, it will be added (stored).

An archiving unit 5 may also be present in the token reference register TRR. Processed registration requests RA and/or processed sequences of registration requests RAF are stored in this archiving unit 5. Further details on the archiving unit are given in FIG. 9.

The token reference register TRR, in particular the verification unit 2 of the TRR, receives and processes a registration request RA of a subscriber unit and/or receives a sequence of registration requests RA_{F} as a sequence and processes this sequence RA_{F}.

FIG. 3a shows an overview of commands CO that can be performed on a token T. These commands CO can be modifications to an existing token T, for example “switch”, “split” or “merge”. The commands CO can also relate to creating (=Create) a token T or deleting (Destroy) existing tokens T. In FIG. 3a, command codes are specified by way of example (0x01 to 0x05), which can then be part of a registration request RA.

FIG. 3b shows an overview of commands CO and their signed registration request syntax RA. In this case, input tokens T and input token references TR are “consumed” per command CO. In this case, output tokens T and output token references TR are “created” per command CO.

A command CO (registration request RA) has the basic structure of the following three elements: command type, input token reference(s), output token reference(s).

Each command CO has a characteristic number of input token reference(s) (“inputs”) and output token reference(s) (“outputs”), which are explained and shown in greater detail in FIGS. 4 to 8.

It should be noted that, for the commands CO “split”, “switch” and “merge”, the difference of the token values v of all participating tokens T or token references TR must give the value “zero”. In other words, these commands CO “split”, “switch” and “merge” do not create any token values v and do not destroy any token values v. This can be checked at the command type CO itself or also by the check unit 3 of the token reference register TRR and is a check criterion for a register request RA.

It is also to be noted that a difference of the token values v of the participating token T or token references TR is allowed only for the commands CO “create” and “destroy”, but only at the level of the token value v of the token T and not beyond.

Each registration request RA can be signed in order to be able to check that the sender of the token reference TR is also in possession of the associated token T. An ECDSA scheme can be applied as a signature. The registration request RA is preferably signed with the private part r of the token T.

For signed registration requests RA_{sig} of the command types CO “create” and “destroy”, a further signature Sig_{TH} of a token issuer TH is required in order to ensure that these commands have been generated by a privileged unit of the transaction system TS.

FIG. 4 shows an exemplary embodiment of a flowchart of a method according to the invention for generating a token T and registering it in the TRR. In addition, the signed registration request RA_{sig} and the command structure is shown in tabular form both from the point of view of the TE layer and of the TR layer.

When generating, there is no input parameter in the TE layer. A random number r is generated in a privileged unit, here the token issuer TH. On the basis of the random number r, a public part R is calculated, as has been described above. IA token reference TR can thus be formed in the token issuer TH starting from the token value v and the public part R by concatenation of v and R.

A registration request RA consisting of the command “CREATE” or the command code according to FIG. 3a and the created token reference TR is signed in the token issuer TH. For this purpose, the private key pKey of the token issuer TH is used.

In the TE layer, the token T is output to the TE1. In the TRR layer, the signed registration request RA_{sig} is output to the TRR.

In the token reference register TRR, the signature of the registration request RA is checked with the public key PKey of the issuing entity TH. This public key PKey_{TH} is known across the transaction system or was made available to the token reference register TRR in advance. If the signature check is successful, then the token reference TR is entered into the token reference register TRR.

In one embodiment, the total token value of the transaction system TS in the check unit 3 of the token reference register TRR is increased by the token value v by the new registration unit 4 of the token reference register TRR.

FIG. 5 shows an exemplary embodiment of a flowchart of a method according to the invention for deleting a token T and registering the deleted T in the TRR. In addition, the signed registration requests RA_{sigTH} and RA_{sig_T} required for this purpose as well as the command structure are shown in tabular form both from the point of view of the TE layer and the TR layer.

When deleting, the token T to be deleted is used as the input parameter in the TE layer and the token reference TRR to be deleted and two signed registration requests RA_{sig_TH} and RA_{sig_T} are used in the TRR layer.

The registration request RA consisting of the command “DESTROY” and the token reference TR to be deleted is signed once with the private key pKey of the token issuer TH.

A further registration request RA consisting of the command “DESTROY” and the token reference TR to be deleted is also signed with the private part r of the token T.

Both signed registration requests are sent to the token reference register TRR. In the token reference register TRR, the signature is checked with the public key of the issuing entity TH. This public key is known across a transaction system or was made available to the token reference register TRR in advance. In addition, the signature of the further registration request RA is checked with the public part of the token reference TR. If both signature checks are successful, then the token reference TR is deleted in the TRR or marked as deleted.

In one embodiment, the total token value of the transaction system TS in the check unit 3 of the token reference register TRR is reduced by the token value v by the new registration unit 4 of the token reference register TRR.

The token reference register TRR or the token issuer TH also causes the token T to be deleted in the subscriber unit TE1.

FIG. 6 shows an exemplary embodiment of a flowchart of a method according to the invention for splitting a token Tₐ and registering the split tokens T_{b} T_{c} in the token reference register TRR. In addition, the signed registration requests RA_{sig_Ta} required for this purpose and the command structure is shown in tabular form both from the point of view of the TE layer and the TR layer.

In the TE layer, a first random number r_{b} and a second random number r_{c} are created by the TE1. Based thereon, a public part R_{b} and R_{c} is then created in each case. The token Tₐ to be split is available in the TE layer as input parameters. In the TE layer, the token value vₐ is split into a first token part value v_{b} and a second token part value v_{c}. The sum of token part value v_{b} and token part value v_{c} has to give the token value vₐ. This ensures that no new token value v is created or no token value v is destroyed.

The token references TR_{b} and TR_{c} are then created by the TE1. The registration request RA then contains the command “SPLIT” or the command code shown for it in FIG. 3a, the input token reference TRₐ and the output token references TR_{b} and TR_{c}. This registration request RA is signed with the random number rₐ of the token Tₐ. The signed registration request RA_{sig_Ta} is sent from the TEI to the token reference register TRR. There, the signature is checked and the sum of v_{b} and V_{c} is formed and compared with the token value vₐ. If vₐ=v_{b}+v_{c} and the signature check is successful, then the token reference TRₐ in the token reference register TRR will be deleted or marked as deleted, and the token references TR_{b} and TR_{c} are entered in the token reference register TRR.

In one embodiment, in the token reference register in the verification unit 2, the token value difference of the input token reference TRₐ and the output token references TR_{b} and TR_{c} is formed and checked to see whether this difference is zero. If the difference is not zero, a token value v will have been generated or destroyed inadmissibly. In addition, the total token value of the transaction system TS can also be checked in the check unit 3 of the token reference register TRR before or after the registration of the token references TR_{b} and TR_{c}. The total token value v in the check unit 3 must not have changed and must correspond to the value before processing of the registration request in the token reference register TRR.

The split token T_{b} (or T_{c}) (which was temporarily transmitted from TE1 to TE2) can now be checked for validity by the subscriber unit TE2 in the TRR.

The registration request RA_{sigTa} can be confirmed by the token reference register TRR by a registration confirmation RB.

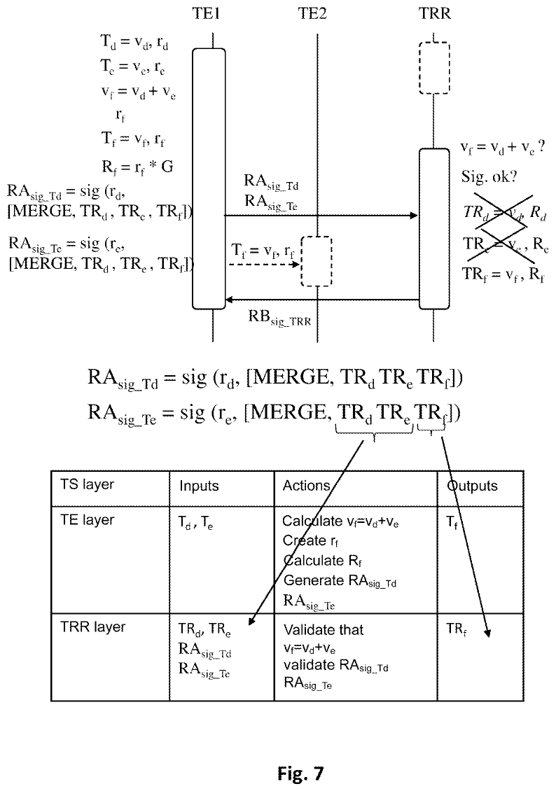

FIG. 7 shows an exemplary embodiment of a flowchart of a method according to the invention for connecting a token T_{d} to a token Tₑ and registering the connected token T_{f} in the TRR. In addition, the signed registration requests RA_{sig_Td} and RA_{sig_Te} required for this purpose as well as the command structure are shown in tabular form both from the point of view of the TE layer and the TR layer.

Here, a random number rr is created in a TE1 of the TE layer. Based thereon, a public part R_{f} is then created. In addition, a sum is formed from the token values v_{d} and vₑ to the token value v_{f} based on the input tokens T_{d} and Tₑ.

The output token reference TRf is then created. A registration request RA then contains the command “MERGE” or the command code listed in FIG. 3a, which comprises two input token references TR_{d} and TRₑ as well as the output token reference TR_{f}. This registration request RA is signed once with the random number r_{d} of the token T_{d} in order to obtain a first signed registration request RA_{sig_Td}. This registration request is also signed with the random number rₑ of the token Tₑ in order to obtain a second signed registration request RA_{sig_Te}. Both signed registration requests RA_{sig_Ta} and RA_{sig_Te} are sent by the subscriber unit TE1 to the token reference register TRR. The signatures of the registration requests RA_{sig_Td} and RA_{sig_Te} are each checked there. In addition, the sum of the token values v_{d} and vₑ is formed and compared with the token value v_{f}. If v_{f}=v_{d}+vₑ and both signature checks are successful, then TR_{d} and TRₑ will be deleted in the token reference register TRR or marked as deleted, and the token reference TR_{f} will be entered in the token reference register TRR. The connected token T_{b} (which was temporarily transmitted from TE1 to TE2) can now be checked for validity by the subscriber unit TE2 in the TRR.

FIG. 8 shows an exemplary embodiment of a flowchart of a method according to the invention for switching a token T_{g} to a token Tₕ and registering the switched token Tₕ in the shown token reference register TRR. In addition, the signed registration requests RA_{sig_Tg} required for this purpose as well as the command structure are shown in tabular form both from the point of view of the TE layer and the TR layer.

Here, random number rₕ is created in a TE1. Based thereon, a public part Rh is then created. In addition, the token value vₕ identical to the token value v_{g} of the input token T_{g} is formed.

The token reference TRₕ is then created. A registration request RA then contains the command “SWITCH” or a corresponding command code according to FIG. 3a, the input token reference TR_{g} and the formed public part Rₕ (or the output token reference TRₕ). This registration request RA is signed with the random number r_{g} of the token T_{g}. The signed registration request RA_{sig_Tg} is sent by the subscriber unit TE1 to the token reference register TRR. The signature is checked there. In addition, the token value v_{g} is compared with the token value vₕ. If v_{g}=vₕ and the signature check is successful, then the token reference TR_{g} in the token reference register TRR will be deleted or marked as deleted, and the token reference TRₕ entered in the token reference register TRR.

FIG. 9 is a further embodiment of a token reference register TRR of a transaction system TS. Optional units are shown with dashed lines.

It is indicated here that several memory units 1 can be kept available in the token reference register TRR. Storing a large number of token references TR in the token reference register TRR can thus be accelerated. It is also indicated that several verification units 2 can be kept available in the token reference register TRR. The verification units 2 can accelerate a verification of registration requests RA. In particular, verification units 2 and/or memory units 1 can work in parallel, for example processing registration requests for different token references in parallel.

In addition, another subscriber unit TE_{B}, for example a bank or a financial services provider, is shown. The token issuer TH can issue tokens directly to the subscriber units TE or indirectly via the additional subscriber unit TE_{B} to the subscriber units TE. This can function as an interface between the transaction system TS and a book money system (lending, account management). The additional subscriber unit TE_{B} also enables subscriber units TE to transfer tokens T of the transaction system TS to another transaction system. This transfer is bidirectional and is optionally carried out using the token issuer TH. The token issuer TH is solely responsible for generating token T and also deleting token T.

In addition, FIG. 9 shows an optional registration request unit RAE, which receives a sequence of registration requests RA_{F} from a subscriber unit TE1. The registration request unit RAE can, for example, forward the sequence RA_{F} as a whole or one after the other in individual RA to the TRR. Only alternatively—not according to the present solution—an RAE could also only send the individual RA to the TRR, so that the TRR would have no knowledge of the existence of the sequence RA_{F}.

It is advantageous if only one token T is used per subscriber unit TE (here as a secure element, e.g. smart card or TEE). However, the subscriber unit TE can also contain several tokens. This means that the TE connects (MERGES) a received token T with the token T stored in the token store. This also means that the TE separates (SPLITS) a token T to be sent from the token T stored in the token memory. These modifications to the token T can initially be carried out without a registration request RA and the token T can be passed on immediately after a modification. There may therefore be a sequence of modifications to the token T that are not known to the TRR. Typically, the sequence of RA registration requests consists of a combination of SPLIT and MERGE modifications. Each of these modifications is also saved as a “proof” (see FIG. 1 above) or signed registration request RAsig with the token T. This creates a sequence of RA_{F} registration requests in the TE.

In the previous FIGS. 1 to 8, a registration request RA was sent from a sequence of registration requests RA_{F}. The TRR may initially remain unaware of whether the RA is an RA from a sequence RA_{F} of RA or not.

It is now advantageous if the TE provides the entire sequence RA_{F} from registration request RA to the TRR as a sequence. The TRR can therefore also process the sequence RA_{F} as a sequence. In particular, the TE can now only receives one registration response (also called registration confirmation) RB for the entire sequence RA_{F} from the TRR.

A terminal device (not shown in FIG. 9) can be provided between the TE and the TRR, into which the TE is inserted ready for operation. The terminal device can access the TE, for example by means of an electronic wallet. The terminal device switches the registration requests RA to the TRR. For this purpose, the terminal device receives the sequence RA_{F}. Alternatively or additionally, a registration request unit RAE can also be provided between the TE and the TRR as a switching instance, see FIG. 9. The RAE then receives the sequence RA_{F} from the TE or the terminal device.

According to FIG. 9, the RAE receives the sequence RA_{F} and sends individual RA from the sequence RA_{F} as part of the sequence to the TRR. The registration of the individual RA is carried out according to the same scheme as shown in FIGS. 1 to 8 and explicit reference is made to this. Alternatively or additionally, the TRR receives the entire sequence RA_{F} at once before the verification is carried out, for example in an API request. The TRR then processes each RA of this RA_{F} individually.

The terminal device (not shown in FIG. 9) or the RAE attempts to transfer the entire sequence RA_{F} to the TRR. This means that the terminal device or the RAE only performs a protocol translation, for example from APDU between terminal device/RAE and TE to HTTP(S). The RA_{F}s are neither analyzed nor interpreted by the terminal device or the RAE. The order of the RA in the sequence RA_{F} is not changed by the terminal device or the RAE. The registration confirmation RB of the TRR is then transmitted from the terminal device and/or the RAE to the TE. Each RA (as shown above in FIGS. 1 to 8 above) is signed with a private part r (the random number r) of a token-individual key pair. A corresponding proof (i.e. the respective RA) is stored in the TE (in the token memory).

The verification unit 2 of the TR checks the validity of all individual RA in the sequence RA_{F} (also referred to as payload) one after the other and translates the final result for all RA into a single RB. This RB has a registration status information, for example “200” if all RA in the sequence RA_{F} have been successfully verified, and for example “400” if not all RA in the sequence RA_{F} have been successfully verified. The RB is sent back to the TE (optionally via the RAE or the terminal device). The RB can be signed with a private key pKey_{TRR} for a key pair of the verification unit 2. The RB can also comprise an RA_{sig}, for example all RA of the sequence RA_{F} or only the last RA of the sequence RA_{F}.

The RAE or the terminal device receives an RB for the entire sequence RA_{F}. This RB is sent to the TE so that this TE can check the validity of the RB and, if the validity is confirmed, remove the sequence RA_{F} from the token memory (=deletion of all proofs of this token T).

If all RA of the sequence RA_{F} have been successfully verified, the verification unit 2 of the TRR (or an equivalent unit of the TRR) only uses the RA_{sig_T} of the chronologically last RA of the sequence in its RB to the TE.

If one of the RA of the sequence RA_{F} could not be verified, the verification unit 2 of the TRR (or an equivalent unit of the TRR) only uses the RA_{sig_T} of the first non-verifiable RA for the sequence RA_{F} in its RB to the TE (a TR to which no T is assignable).

The TE checks the registration information of the RB and behaves differently depending on whether all RA in the sequence RA_{F} have been successfully verified (e.g. status “200”) or whether one RA in the sequence RA_{F} has failed verification (e.g. status “400”).

If all RA in the sequence RA_{F} are successfully verified (e.g. status “200”), the following algorithm is triggered in the TE:

Step 1: Thread the chronologically last RA for the sequence RA_{F} from the token memory;

Step 2: Check the signature RA_{sig_T} from the RB with the public part R. If the signature RA_{sig_T} cannot be checked, continue with step 6;

Step 3: If RA_{sig_T} of the RB is verifiable, the signature of verification unit 2 is checked with the public part PKey_{TRR} of the key pair for verification unit 2;

Step 4: If the signature of verification unit 2 is verifiable, delete all RA of the sequence RA_{F} from the token memory of the TE. If the chronologically last RA can be successfully verified in verification unit 2, this means that all previous RA in the sequence RA_{F} must also have been verified. This always occurs, for example, if the TE always (only) keeps available one token T and subtracts or adds further token values v from the token value v of token T with modifications (split/merge).

Step 5: If the signature of verification unit 2 cannot be verified, the protocol has been violated. A man-in-the-middle attack is assumed; the registration requests RA are not deleted from the token memory of the TE.

Step 6: If RA_{sig_T} of the RB is not verifiable, the entire sequence is iteratively checked to find the RA for which RA_{sig_T} from the RB is verifiable. The sequence RA_{F} can be iterated in two directions, either from the oldest RA to the newest RA or from the newest RA to the oldest RA. If a matching RA is found in the sequence RA_{F}, steps 3 to 5 are executed.

This algorithm is now explained using an example in which two modifications are made to a token T:

Modification 1 (SPLIT, see also FIG. 6): The token value vₐ of the token Tₐ is divided from v=100 into v_{b}=30 and into v_{c}=70.
Modification 2 (MERGE, see also FIG. 7): The token value v_{b}=70 is combined with a token value v_{d}=50 of another token T_{d} to form a new token value vₑ=120.

The corresponding RA for the two modifications are:

### RA1=[SPLIT, 100, 8, 30, 9, 70, 10]

### RA2=[MERGE, 70, 10, 50, 6, 120, 11]

The TE calculates (see also FIGS. 6 and 7) three RA_{sig_T}:

### RA_{Sig1}=sig(r1, RA1)

### RA_{Sig2A}=sig(r2, RA2)

### RA_{Sig2B}=sig(r3, RA2)

RA_{Sig2A} and RA_{Sig2B} can be transmitted together or form a common signed RA. The TRR checks the validity and confirms all RA_{Sig} (=proofs) by sending the following response RB back to the TE:

Status=200, Sig2A, sig(pKey_{TRR}, [200, Sig2A, Sig2B])

If verification of an RA fails in the sequence RA_{F} (e.g. status “400”), the following algorithm is executed:

Step 1: Find the chronologically oldest RA in the sequence RA_{F} that can be verified with the RA_{sig_T} of the RB. The sequence RA_{F} can be iterated in two directions, either from the oldest RA to the newest RA or from the newest RA to the oldest RA.

Step 2: If the RA_{sig_T} of the RB can be verified with an RA of the sequence RA_{F}, the signature of verification unit 2 is checked with the public part PKey_{TRR} of the key pair of verification unit 2. If the signature of verification unit 2 cannot be verified, the protocol has been violated. A man-in-the-middle attack is assumed; the registration requests RA are not deleted from the token memory of the TE.

Step 3: If the signature of verification unit 2 is verifiable, no RA (proofs) are deleted. Optionally, failed RA can be marked or the RA can be kept in the token memory of the TE to make it easier to identify the failed RA if this is requested later.

This algorithm is now also explained using an example. Four modifications (SPLIT, MERGE, MERGE, SPLIT) will be carried out on a token T:

Modification 1 (SPLIT, see also FIG. 6): The token value vₐ of the token Tₐ is divided from v=100 into v_{b}=30 and into v_{c}=70.
Modification 2 (MERGE, see also FIG. 7): The token value v_{b}=70 is combined with a token value v_{d}=50 of another token T_{d} to form a new token value vₑ=120.
Modification 3 (MERGE, see also FIG. 7): The token value vₑ=120 is combined with a token value v_{f}=40 of another token T_{f} to form a new token value v_{g}=160.
Modification 4 (SPLIT, see also FIG. 6): The token value v_{g}=160 is divided into vₕ=100 and vᵢ=60.

The corresponding RA for the four modifications are:

### RA1=[SPLIT, 100, 8, 30, 9, 70, 10]

### RA2=[MERGE, 70, 10, 50, 6, 120, 11]

### RA3=[MERGE, 120, 11, 40, 5, 160, 13]

### RA4=[SPLIT, 160, 13, 60, 17, 100, 3]

The TE calculates (see also FIGS. 6 and 7) six RA_{sig_T}:

### Ra_{Sig1}=sig(r1, RA1)

### RA_{Sig2A}=sig(r2, RA2)

### RA_{Sig2B}=sig(r3, RA2)

### RA_{Sig3A}=sig(r4, RA3)

### RA_{Sig3B}=sig(r4, RA3)

### RA_{Sig4}=sig(r6, RA4)

RA_{Sig2A} and RA_{Sig2B} as well as RA_{Sig3A} and RA_{Sig3B} can be transmitted together or form a common signed RA. The TRR checks the validity and determines that RA3 is invalid and sends the following response RB back to the TE:

Status=400, Sig3A, sig(pKey_{TRR}, [400, Sig3A, Sig3B])

It is not obvious to the TE that if the TRR sends an RB with status code 400, the token(s) T associated with this RB is/are forged. It may happen that all RA within the TE are valid and contain real/valid token T, but the TRR still responds with an RB with status (error code) “400” to a registration request of the sequence RA_{F}. The status (error code) “400” initially causes the registration of the sequence RA_{F} to be aborted. The sequence RA_{F} may already be partially processed and the memory unit 1 has already been partially updated using parts of the sequence RA_{F}.

This abort or only partial processing (execution) can occur due to network or transmission errors. For example, there are problems with data transmission during the registration of the sequence RA_{F} of RA registration requests. In such cases, the TRR responds with an error status code (e.g. “400”) in the RB, which does not necessarily mean that the relevant tokens T of the TE are forged.

According to the invention, a data protection and data integrity mechanism now provides for detecting any kind of manipulation of the sequence RA_{F} during transmission to the TRR. Before sending the sequence RA_{F}, the TE calculates a secure checksum (e.g. hash value) for the sequence RA_{F} (preferably without the signatures) and stores the hash/check result securely in the token memory of the TE. This hash/checksum result is confidential and is not transmitted out of the TE. If the verification unit 2 of the TRR wishes to register the sequence RA_{F}, the verification unit 2 of the TRR also calculates a secure hash/checksum via the sequence RA_{F}. Later, the verification unit 2 of the TRR will only include this hash/checksum result in the RB in the event of error scenarios (e.g. error status code “400”). In the event of an error, this additional hash/checksum in the RB helps to analyze whether the error occurred due to transmission manipulation/errors or due to a forged token T. The verification unit 2 of the TRR can optionally also include this hash/checksum result in the RB (e.g. in the signature of the RB) in the event of success scenarios (e.g. success status code “200”).

The hash/check value can be part of the signature of verification unit 2. If the TE now checks the signature of verification unit 2, the TE must retrieve the stored hash/checksum from its token memory. If the TE can establish this assignment, this means that the sequence RA_{F} has not been manipulated (e.g. by a switching instance, such as a terminal device, RAE, or a man-in-the-middle instance).

The process (sending the sequence RA_{F}) will then simply be repeated, the corresponding RA with signatures are still available in the TE. The only partially processed sequence RA_{F} can be obtained from an archiving unit 5 of the TRR.

This abort or only partial processing (execution) can also or alternatively occur due to a malfunction of a TE. For example, a malicious TE has deliberately changed either the order of the RA or the syntax of the RA, as a result of which the TRR cannot verify the RA (fraud attempt). For example, an invalid RA was received in the sequence RA_{F} due to malfunctioning of the TE or due to data transmission errors or for other reasons.

If the TE receives an RB with error status code 400, it first identifies the failed RA, see above. With the associated hash/check result, the TE can also attempt to verify the signature of verification unit 2.

If the signature verification fails, then either the RA_{F} data was manipulated during transmission or the response did not come from verification unit 2, but some third party posed as verification unit 2 but was unable to create a valid signature. The TE then ignores the RB without any changes in the token memory of the TE.

This abort or this only partial processing (execution) can also or alternatively occur due to a non-assignable TR. For example, there was never an assignable token T (fraud attempt) or the assignable token T has already been modified again (split, merge, switch) and a token reference TR exists in the TRR for this modification or the assignable token T has already been issued (illegal multiple issue attempt) or the assignable token T has been deleted (token value v has been redeemed).

For such an analysis, a proper examination using the archiving unit 5 (and optionally the verification unit 3 and/or the new registration unit 4) is required.

In such a case, the TRR transfers the entire outstanding RA_{F} to archiving unit 5. However, this application can also be installed in an ATM terminal or a web server. It specializes in analyzing and correcting billing errors and generating a blacklist of forged tokens T (based on the token references TR) currently circulating in the off-line world. The aim is to reset the TE and the token memory (including the sequence RAF) and load a replacement token T onto the TE.

The TE or the RAE or the terminal device sends the (entire) sequence RA_{F} to the archiving unit 5 together with the RB of the verification unit 2 of the TRR. The RB can serve as confirmation that the registration of the sequence RA_{F} has been canceled.

The archiving unit 5 of the TRR checks every RA of the sequence RA_{F} both syntactically and semantically with the aid of the verifying unit 2 of the TRR. For this purpose, the archiving unit 5 has read/write access to the memory unit of the TRR. The TR within an RA are checked individually.

Those TR that are unknown to verification unit 2 of the TRR are kept in an active part of archiving unit 5. The verification unit 2 of the TRR also has access to this active part of archiving unit 5.

The archiving unit 5 may request transaction log records from the TE corresponding to the failed RA and the RA or TR listed in the archiving unit 5. This information from the TE can be used to identify and track malicious TE.

The archiving unit 5 can have replacement tokens generated with the entire token value (including the token values from the archiving unit 5) or only from the verified RA and valid TR according to the memory unit 1, for example by the new registration unit 4.

The token memory of the TE is emptied and loaded with this replacement token.

The value neutrality of the registration requests RA is checked in the verification unit 2. For each registration request of a subscriber unit TE, it checks whether the sum of the input token values is equal to the sum of the output token values. The test unit 3 checks the total value of the stored token values in the memory unit 1, for example before or after the processing of a sequence RA_{F} and/or at selected times (periodically or quasi-randomly). The check unit 3 compares the currently stored total token value with a reference value. The reference value is adjusted when the token issuer TH deletes or initially registers tokens via its interface, the new registration unit 4.

1.-23. (canceled)

24. A method for registering tokens of an electronic transaction system comprising secure elements as transaction units, each token of the transaction system having at least one token value and one private part of a token-individual key pair acting as token elements, comprising the method steps:
receiving registration requests in a token reference register of the transaction system, the registration requests each having at least two token references, with at least one token reference of a first registration request of the registration requests and one token reference of a second registration request of the registration requests being identical;
verifying, using a verification unit of the token reference register, whether a token reference of a registration request can be uniquely assigned to a token of the transaction system, the token reference being checked to see whether it is or was stored in the token reference register;
storing at least one token reference other than the checked token reference in the memory unit of the token reference register for registering the token uniquely assigned to this token reference in the transaction system if it is established in the verification step that a token of the transaction system can be assigned to the checked token reference;
wherein in the receiving step, the registration requests are received in the token reference register as a sequence of registration requests, and in the verification and storage steps, the registration requests are processed in the token reference register as a sequence of registration requests.

25. The method according to claim 24, wherein each token reference other than the other token reference from the sequence of registration requests was or is uniquely assigned to a token in the transaction system, and
wherein in particular the tokens in a direct transaction layer of the transaction system were transmitted directly between subscriber units of the transaction system and/or were modified by a subscriber unit without these tokens being registered in the transaction system.

26. The method according to claim 24, wherein in the receiving step, the registration requests are received as a sequence of registration requests of one of the secure elements; and/or
at least the first and second registration requests of the sequence contain a previously unregistered token present in the subscriber unit, in particular the secure element.

27. The method according to claim 24, wherein the entire sequence of registration requests is received in the token reference register before the verification step is executed; and/or
the verification step is executed for at least one token reference from each registration request; and/or
the storage step is executed for the other token reference, in particular in each case, if the other token reference is not yet stored; and/or
at least three registration requests of the sequence comprise a token reference, which is also the token reference of another registration request of the sequence.

28. The method according to claim 24, wherein the entire sequence of registration requests is sent from a subscriber unit of the transaction system to a registration request unit of the transaction system before the verification step is executed, and
wherein the token reference register sequentially receives and verifies each registration request from the sequence of registration requests from the registration request unit, before the next registration request from the sequence of registration requests is received and verified.

29. The method according to claim 24, wherein the sequence of registration requests is stored in an archiving unit of the token reference register.

30. The method according to claim 24, wherein each registration request from the sequence of registration requests is stored in an archiving unit of the token reference register, in a first part of the archiving unit, if it is established in the verification step that the checked token reference of one of the registration requests of the sequence of registration requests cannot be uniquely assigned to any token of the transaction system.

31. The method according to claim 30, wherein a sequence of registration requests with token references is stored in a second part of the archiving unit if all token references of the sequence of registration requests can each be uniquely assigned to a token of the transaction system.

32. The method according to claim 24, wherein the token references of the sequence of registration requests are verified chronologically backwards.

33. The method according to claim 24, wherein each token reference comprises at least the token value of the token and a public part of the token-individual key pair as token reference elements,
wherein the public part of the token-individual key pair was obtained by applying a cryptographic one-way function to the private part of the token-individual key pair of the token.

34. The method according to claim 33, wherein the registration request is signed with the private part of the token-individual key pair in order to be able to verify an assignment of the token reference to the token.

35. The method according to claim 24, wherein each token reference has been obtained by masking the associated token by applying a homomorphic one-way function to the token.

36. The method according to claim 24, further comprising the method steps of:
generating, from the verification unit of the token reference register, a registration response,
wherein the registration response indicates a result of the verification step;
sending the registration response to a subscriber unit or registration request unit of the transaction system sending the registration request from the sequence of registration requests, the subscriber unit having the token of the at least one token reference of the sequence of registration requests.

37. The method according to claim 24, wherein
the sequence of registration requests is provided by a subscriber unit, and/or
wherein each registration request of the sequence comprises at least one token reference as an output token reference and at least one input token reference, and/or
wherein the registration requests of the sequence are linked to each other, in particular, in each case, an output token reference of a registration request of the sequence forming an input token reference of the next registration request of the sequence.

38. A token reference register for a transaction system, configured for performing the method steps according to claim 24.

39. The token reference register according to claim 38, comprising:
at least one memory unit for storing token reference for registering tokens in the transaction system;
at least one verification unit for verifying whether a token reference of a received registration request is stored in the token reference register;
an archiving unit for storing sequences of registration requests; and
a new registration unit for registering tokens newly generated by a token issuer or tokens deleted by a token issuer.

40. The token reference register according to claim 38, wherein the memory unit is configured such that:
a subscriber unit or a registration request unit only has write access—in particular by means of registration requests—to the memory unit; and/or
the archiving unit and/or the verification unit has read and write access to the memory unit.

41. The token reference register according to claim 38, configured for receiving a plurality of registration requests, which are verified in parallel in a majority of verification units as to whether the at least one token reference contained in the respectively received registration request is uniquely assigned to a token of the transaction system, with all registration requests of a sequence of registration requests being verified sequentially one after the other in the same verification unit in each case.

42. A secure element as a subscriber unit in a transaction system having:
an interface, configured for:
transmitting token to another subscriber unit;
transmitting, to a token reference register or a registration request unit of the transaction system, a registration request comprising at least a first and a second token reference;
an access means to a token memory or token memories, wherein at least one token of the secure element is stored in the token memory; and
a computing unit, configured for:
applying a cryptographic one-way function to a private part of a token-individual key pair of a token of the token memory for obtaining a token reference; and
modifying token.

43. The secure element as a subscriber unit according to claim 42,
wherein a sequence of registration requests is stored in the token memory; and/or
wherein the subscriber unit is configured to send registration requests as a sequence of registration requests to the token reference register; and/or
wherein the subscriber unit is configured to receive only a registration confirmation for the sequence of registration requests from the token reference register .

44. The secure element as a subscriber unit according to claim 42,
wherein only one token is stored in the token memory; and/or
wherein, for transferring a token to another subscriber unit, the token is split,
wherein a registration request is generated for this purpose, the registration request having a token reference of the token to be split and, in each case, a token reference of the split tokens; and/or
wherein, when a token is received from another subscriber unit, the received token is merged to the token in the token memory,
wherein a registration request is generated for this purpose, the registration request having a token reference for the merged token and, in each case, a token reference of the tokens to be merged.

45. A transaction system comprising:
a register layer having a token reference register for registering token references; and
a direct transaction layer having a plurality of subscriber units, in particular comprising secure elements according to claim 42, which are configured for the direct exchange of tokens with one another.

46. The transaction system according to claim 45, wherein the register layer comprises a registration request unit,
wherein the entire sequence of registration requests is sent from a subscriber unit of the transaction system to the registration request unit of the transaction system before the verification step is executed, and
wherein the token reference register receives the registration request from the sequence of registration requests from the registration request unit.
